(19) United States
(12) Patent Application Publication
(10) Pub. No.: US 2024/0302478 A1
(43) Pub. Date: Sep. 12, 2024

(54) SYSTEM AND METHOD FOR STORING POSITION INFORMATION IN A FIELD DEVICE

(71) Applicant: VEGA Grieshaber KG, Wolfach (DE)

(72) Inventors: Florian Zimmerman, Dunningen (DE); Michael Schnaitter, Steinach (DE)

(21) Appl. No.: 18/598,060

(22) Filed: Mar. 7, 2024

(30) Foreign Application Priority Data
Mar. 7, 2023 (EP) 23160585.8

(51) Int. Cl. G01S 5/00; G01S 5/02

(52) U.S. Cl. CPC G01S 5/0027; G01S 5/0284

(57) ABSTRACT

A system for storing position information in a field device comprises at least a field device and a mobile terminal. The field device has at least one sensor for detecting a physical variable and field device electronics to actuate the at least one sensor and including at least a control unit, a communication interface and a memory. A position determination unit in the mobile terminal is designed to determine position information for describing the position of the mobile terminal in a space. Communication interfaces of the mobile terminal and field device mutually exchange data, preferably short range, and transmit position information from the mobile terminal to the field device. The control unit of the field device stores position information determined by the mobile terminal and received via the communication interface in the memory. A corresponding field device and a corresponding method are also disclosed.

### FIELD OF THE INVENTION

The invention relates to a system and a method for storing position information in a field device using a mobile terminal, as well as to a corresponding field device and a corresponding computer program product.

### BACKGROUND OF THE INVENTION

Field devices are frequently used in the field of automation technology and can have both actuators and sensors. The sensors have at least one sensing unit with which a physical variable can be detected. This physical variable can include, for example, a distance, a length, a volume, a fill level, a pressure, a temperature, a concentration, a flow rate, a humidity, a light intensity, a voltage, a current and/or the like. Sensor data for further use is obtained from the recorded physical variable.

In practice, it is often not only the sensor data itself that is of interest, but also the position of the field device that acquired the sensor data. This position information can be used in various ways. For example, it is easier to assign the sensor data to a location in a production line or in an industrial plant, it is easier to locate the field device during maintenance, or similar.

For stationary field devices, the position can be stored manually in an inventory system. However, this approach is time-consuming and error-prone. Furthermore, this approach is not always suitable when using position information, as an ongoing connection to the inventory system is required.

This approach can be simplified using EP 3 217 629 A1. During a new registration, position information is obtained using a mobile device and sent to an Internet portal. The position information is stored in the internet portal together with identification information of the field device. This considerably simplifies the inventory process. However, the need remains for a connection to the inventory system to utilize the position information.

Another approach is to equip the field device with a position determination unit. These position determination units can utilize a GNSS—Global Navigation Satellite System—which is formed, for example, by GPS—Global Positioning System—or Galileo. However, such position determination units require sufficient signal strength of the satellite signals, which excludes measurement in a cellar or under a metal roof or makes it very energy-intensive. Furthermore, these position determination units generate not inconsiderable additional costs.

Another approach is disclosed in EP 3 128 805 A2. There, an RFID tag is arranged on a sensor, with location data and identification information being stored in said RFID tag. An RFID reader reads the information from the RFID tag and transmits it to a server. When the server receives messages from a sensor, the server can link the message to the previously received location. The disadvantage is that here, too, the position must first be stored manually in the RFID tag. Furthermore, the location information is only available to the RFID reader or the server and can therefore only be used to a limited extent.

### SUMMARY OF THE INVENTION

The invention addresses the problem of providing a system, a field device, a method and a computer program product in which position information for a field device can be stored in a simple and less error-prone manner and can be made available for access by the field device in a simple manner.

This problem is solved by the feature combinations of the independent claims. Further embodiments are disclosed in the respective dependent claims.

It should be noted that the features described individually in the claims can be combined with each other in any technically feasible way (even across category boundaries, for example between method and device) and demonstrate further embodiments. The description additionally characterizes and specifies the invention, in particular in conjunction with the figures.

It should also be noted that a conjunction “and/or” used herein between two features and linking them together is always to be interpreted such that in a first embodiment only the first feature may be present, in a second embodiment only the second feature may be present, and in a third embodiment both the first and the second feature may be present.

It has been recognized that in many application scenarios, the position of a field device does not change or changes extremely rarely. In such cases, it is therefore not necessary for the field devices to have their own means of determining their position. GNSS receivers can therefore usually be dispensed with. Instead, according to the present disclosure, a mobile terminal is used which has a position determination unit and can transmit position information to the field device via a communication interface. The field device can store this position information in a memory. In order to make the position information available for later use by field device electronics, this memory can be located in the field device electronics. In this way, position information can be stored in the memory, for example when setting up or parameterizing the field device, and kept available for later use.

A system that can realize this basic idea comprises a field device and a mobile terminal. The field device comprises at least one sensor, field device electronics, a communication interface, a memory and a control unit. One task of the field device electronics can be to actuate the sensor or its at least one sensing element for the respective detection of a physical variable. However, the field device electronics can also include the communication interface and the control unit. In addition, the memory for the position information is located in the field device electronics. The mobile terminal also comprises a communication interface and a position detection unit. The communication interface of the field device and the communication interface of the mobile terminal are designed in such a way that a mutual exchange of data is possible. In practice, this should be achieved in particular by the fact that the two communication interfaces correspond to the same or compatible technology.

During operation of this system, the position detection unit determines position information and sends it—either directly or in an adapted form—to the field device via the communication interfaces. The control unit of the field device receives the position information and stores it in the memory. In this way, the position information can be made available for further use.

The term “field device” generally refers to a device that has at least one sensor with at least one sensing element. The field device can also have other components, such as an actuator. Even if the term is mainly used in automation technology and this is also a preferred field of application, it should nevertheless be noted that the present disclosure is not necessarily limited to automation technology. The present disclosure can be used wherever the localization of sensors is required and the position of the sensors does not change or rarely changes. This may also include the sensors being stationary within a reference system and the reference system moving. Such a reference system can be, for example, a train, a shipping container or a ship.

The “sensing element” is defined in the present case as the part of the sensor that detects a physical variable and converts it into an electrical signal. How exactly this conversion takes place is not significant and will depend on the particular physical variable to be detected. By way of example only, reference is made to the detection of a distance, a length, a volume, a filling level, a limit level, a pressure, a temperature, a concentration, a flow rate, a humidity, a light intensity, a voltage or a current, however, these examples should not be understood as an exhaustive or restrictive list.

The “field device electronics” can be implemented in a wide variety of ways. Implementation on a printed circuit board is conceivable. However, several interconnected circuit boards can also be used. The field device electronics are likely to be made up of various components comprising passive components and active components. Integrated circuits are also likely to be used, for example one or more processors. The field device electronics can also be part of an exchangeable electronics unit, which can function as a display and/or operating unit, for example.

The term “control unit” refers in the present case to the function of receiving position information and storing the received position information in the memory. This does not mean that the control unit of the field device can only realize these functions. Rather, the present disclosure also covers the fact that the control unit controls further functions of the field device.

The “control unit” can be implemented in the field device electronics. The function of this control unit can be implemented together with other functions of the field device in a processor, a logic circuit or the like. However, in view of the energy-efficient benefit of the present disclosure, it may also be suitable to implement the control unit in a separate part of the field device electronics, for example a separate microcontroller. In this way, only this separate part can be supplied with energy in a set-up mode, while other parts of the field device electronics can be switched off or remain in a sleep mode.

The “mobile terminal” can also be implemented in various ways. It is essential that the mobile terminal can communicate with the field device via a communication interface and comprises a position detection unit. In addition, it should be advantageous for the purpose disclosed here if the mobile terminals are mobile, i.e. their position can be changed relatively flexibly. The manner in which these requirements are fulfilled is not of decisive importance. In one embodiment, the mobile terminal is formed by a dedicated handheld device that is specifically designed for the use disclosed herein. In another embodiment, the mobile terminal is formed by a smartphone, smartwatch, tablet or other multipurpose mobile device which is made usable by suitable software for use in the system disclosed herein.

The “communication interface” can also be designed in various ways. It is important that the field device and the mobile terminal can exchange data with each other via this communication interface. This usually means that the communication interfaces correspond to the same standard or generally the same technology or are at least compatible with each other. In practice, however, this requirement can be fulfilled by a wide variety of communication interfaces. As there are usually no large amounts of data to be exchanged and a transmission delay is usually of little significance, in principle, rather slow communication interfaces with only a low transmission rate can also be used. Both wired and wireless communication interfaces can be used. Due to their easier handling, the latter are preferred, especially radio-based communication interfaces.

As the position information that is to be stored for the field device is based on the position information for the mobile terminal, it may also be advisable if there is not too great a distance between the field device and the mobile terminal when determining and storing the position information. The safest way to ensure this is to ensure that the communication interface only has a limited range. The communication interface is therefore preferably designed for short-range communication, i.e. the participating communication partners must not be too far away from each other for communication to take place. In practice, this routinely means that the distance is a maximum of 100 meters, in many cases a maximum of 50 meters. Preferably, the range of the communication interface is a maximum of 20 meters.

Examples of wireless communication interfaces that can be used in principle are WLAN (Wireless Local Area Network), Bluetooth, Bluetooth LE (Low Energy Bluetooth), UWB (Ultra Wide Band), NFC (Near Field Communication) or Qi. Again, this list should not be understood as exhaustive or restrictive.

WIFI, also known as wireless LAN (WLAN) in accordance with IEEE 802.11, refers to data transmission via radio signal. This is probably the most common standard for data transmission via radio in the office, home and industrial sectors.

Bluetooth is an industry standard in accordance with IEEE 802.15.1 for data transmission via radio signal over short distances, for example a maximum of 10 meters.

UWB describes an approach for short-range communication in which a frequency range with a large bandwidth of typically at least 500 MHz or at least 20% of the arithmetic mean between a lower and an upper cut-off frequency of the frequency band used is used. The data is transmitted in pulses that are as short as possible. UWB technologies are described, for example, in IEEE 802.15.3a or IEEE 802.15.4a.

NFC is an international transmission standard based on RFID technology for the contactless exchange of data via electromagnetic induction using loosely coupled coils over short distances of a few centimeters at a frequency of 13.56 MHz.

Qi is a proprietary standard of the Wireless Power Consortium for wireless energy transmission. This allows smartphones or smartwatches, for example, to be charged without contact. Common transmission capacities are between 5 watts and 15 watts. Data can also be transferred at a data rate of a few kilobits per second.

What “position information” specifically means in the context of the present disclosure is likely to depend on the particular application scenario. In general, the position information should be able to describe the position of the field device in a space. In this context, the term “space” may specifically refer to a specific space or abstractly to a three-dimensional arrangement. It may be sufficient for the field device to be assigned to a specific area or a specific building, for example. However, it may also be necessary to know the position of a field device more precisely, for example whether a field device is used in a specific system, a specific machine or a specific part of a machine. Depending on the application scenario, the position information should be suitable for the required accuracy.

The position information can be represented in various ways. For example, the position information can be limited to an area, a building, a plant or a machine. Preferably, however, the position information specifies coordinates in a space at or near which the field device is located. These coordinates can be global coordinates. However, the coordination can also be relative coordination, so that the position of the field device can be defined relative to a reference point. These few examples, which should not be understood as exhaustive or limiting, show how universal the position information is.

Accordingly, the “position determination unit” can be designed in various ways. It should be important that a position in the vicinity of the field device can be determined with the position determination unit. This is because the mobile terminal is preferably not moved or is only moved insignificantly relative to the field device between the determination of the position by the position determination unit and the storage of the position information in the field device. If no GPS signals can be received by the field device, a GPS receiver is unsuitable as a position determination unit. Other position determination units must then be used. Otherwise, an existing position determination unit may be used with an existing mobile terminal. Provided that these are capable of determining the position information with sufficient accuracy, they can in principle be used within the scope of the present disclosure. If a mobile terminal is designed specifically for the use disclosed herein, the required accuracy of the position information can form a starting point for the selection of a suitable position determination unit.

The “memory” can also be designed in various ways. It may be advisable for the memory to be non-volatile so that the position information is retained even after a power supply is disconnected. Examples include EPROM (Electronically Programmable Read Only Memory), EEPROM (Electronically Erasable Programmable Read Only Memory), MRAM (Magnetoresistive Random Access Memory), NVRAM (Non Volatile Random Access Memory) or flash memory. However, a volatile memory could also be used, the memory content of which is protected, for example, by a buffer element such as a gold cap (or other capacitor) or an accumulator. RAM (random access memory) is an example of this.

It should be noted that the “memory” does not necessarily have to be a dedicated memory module for storing position information. Rather, the “memory” could also be a sub-area of a memory provided for other purposes. On the other hand, the “memory” also does not have to be available exclusively for storing position information, as long as the ability to store position information remains guaranteed. For example, information could also be stored in the “memory”, such as a time of position determination, a last user, identification of the mobile terminal used, general diagnostic data, environmental data (such as language, country, altitude), etc.

The system disclosed here can be implemented in various ways. In principle, the system, in particular the field device and the mobile terminal, can be implemented entirely by hardware. In another embodiment, the system is implemented by a combination of hardware and software. The hardware can include sensors, analog-to-digital converters, filters (for example high-pass, low-pass, band-pass filters), processors (for example a microcontroller, digital signal processor or ASIC (Application Specific Integrated Circuit)) and/or a programmable logic circuit (for example an FPGA (Field Programmable Gate Array) or CPLD (Complex Programmable Logic Device)). Furthermore, one or more additional memories may be present, for example RAM (Random Access Memory), ROM (Read Only Memory) or Flash memory, which can be accessed by other hardware components. Software can control the respective components, for example the processor or parameters of an analogue-to-digital converter. In the case of a mobile terminal, which is formed by a smartphone or a tablet, an operating system, for example Android or iOS, can also be used, wherein the functionality for use in the system disclosed here can be achieved by corresponding programs, for example apps.

In one embodiment, the mobile terminal is designed to transmit position information determined by means of the position determination unit to the field device via the communication interface, wherein the position information determined by means of the position determination unit is assumed to be representative of the position of the field device. In this way, it is particularly easy to determine position information for the field device. This approach can provide precise position information for the field device if the mobile terminal is sufficiently close to the field device when the position is determined using the position determination unit. How close the mobile terminal should be to the field device for this purpose can depend on various factors. The higher the accuracy of the position determination by the position determination unit, the more interesting is a spatial proximity between the mobile terminal and the field device. “Proximity” can be a distance of less than 10 meters, in another embodiment a maximum of 2 meters, in yet another embodiment a maximum of 1 meter, in a further embodiment a maximum of 50 centimeters, in a still further embodiment a maximum of 10 centimeters. Sufficient “proximity” could be achieved on the one hand by a corresponding indication to an operator. The system could then assume that the operator is holding the mobile terminal sufficiently close to the field device when the procedure is triggered. Additionally, or alternatively, technical means can ensure this “proximity”, for example by determining a distance between the mobile terminal and the field device or by using communication interfaces with a sufficiently short range.

In one embodiment, the mobile terminal is designed to determine a relative position of the field device relative to the mobile terminal and, based on position information determined by means of the position determination unit and the relative position of the field device, to determine adapted position information for the field device and to transmit the adapted position information to the field device via the communication interface. Adapting the position information in this way enables precise position determination with a high degree of freedom in operation. This is because field devices cannot always be reached easily enough at their installation position. The relative position between a mobile terminal and the field device could, for example, be determined from the propagation times of radio signals at different positions.

In one embodiment, the field device electronics are designed to access and/or utilize position information stored in the memory. In this way, added value can be generated from the position information. For example, the field device can send a determined measured value together with position information to a cloud system.

In one embodiment, the communication interface of the mobile terminal and/or the communication interface of the field device is designed for wireless, preferably radio-based, communication with a maximum range of 10 meters, particularly preferably with a maximum range of 5 meters, very particularly preferably with a maximum range of 1 meter, more preferably with a maximum range of 0.5 meters. With a maximum range of 10 meters, the number of field devices that can potentially be received simultaneously can be kept small. At the same time—especially when determining the relative position of the field device relative to the mobile terminal—the determination of the relative position can be sufficiently accurate. These effects can be further improved at a range of maximum 5 meters. At a range of no more than 50 centimeters, the positions between the mobile terminal and the field device match quite precisely, so that it is usually not necessary to adapt the position information determined by the position determination unit. This effect can be further improved if the maximum range is only 10 centimeters.

In one embodiment, the communication interface of the mobile terminal and the communication interface of the field device are also designed to transmit energy from the mobile terminal to the field device, wherein energy transmitted via the communication interface can preferably be used to supply the control unit and the memory of the field device. In this way, field devices that are not yet or not currently connected to a power supply can also be provided with position information. For example, a field device may already have been mechanically installed without a bus connection to supply the field device. Nevertheless, the parameterization of the field device can still be accessed. It is also possible that the field device is completely disconnected from the power supply for parameterization or that the sensor is currently inactive. Overall, further flexibility can be achieved by transferring energy via the communication interface.

In one embodiment, the communication interface of the mobile terminal and the communication interface of the field device are based on Bluetooth, Bluetooth LE, NFC—Near Field Communication—or Qi. Bluetooth is a widely used wireless standard, meaning that a large number of potentially suitable mobile devices are available. As a low-energy version of Bluetooth, Bluetooth LE can reduce energy consumption. NFC is a communication technology that is implemented in almost all modern smartphones, smartwatches, and tablets, meaning that a large number of usable mobile devices are available. Furthermore, the range of NFC is quite short, so the positions of the mobile device and the field device must be quite close to each other. Qi is known for charging smartphones or other mobile devices. However, data can also be transmitted via the interface in addition to energy, wherein the relatively low data rate is perfectly adequate for the purposes at hand. In addition, a maximum distance of a few centimeters is required between the mobile terminal and the field device, so that their positions can be assumed to be practically identical. The energy should be transmitted from the mobile terminal to the field device.

In one embodiment, the field device has a power supply, preferably in the form of a battery and/or in the form of means for energy harvesting, wherein the power supply is designed to supply at least parts of the field device electronics. In this way, the field device electronics can also be operated without a dedicated energy transfer from outside. Energy harvesting can be understood as all measures with which energy is obtained from external sources without dedicated connections. This also includes photovoltaic modules, for example.

In one embodiment, the field device has a further communication interface, wherein the further communication interface is preferably designed for communication with a bus. Providing a further communication interface offers a more universal communication option for the field device, for example for sending measured values, status or warning messages or for accessing the field device from a control device. The communication interface used to receive the position information from the mobile terminal could also be used for this type of communication. However, an additional communication interface offers greater flexibility, for example in terms of range. The additional communication interface can be wired or wireless. It can be designed for short-range or long-range communication. Examples include an interface according to the 4-20 mA standard, for a Profibus, LoRaWAN, LTE-M (Long Term Evolution for Machine type communication), NB-IoT (Narrow Band Internet of Things), WirelessHART (IEC 62591), Sigfox (Sigfox Proprietary) or GSM (Global System for Mobile communications), to name just a few generally possible examples. In a development, the additional communication interface enables a connection to a data bus. In this way, the connection effort and management of the field device can be simplified.

In a development, the additional communication interface is designed to be used for energy transmission to supply at least parts of the field device electronics. In this way, the field device can be easily supplied with power during operation. In most cases, this development is likely to be realized together with a wired configuration of the further communication interface.

In one embodiment, the position determination unit comprises a receiver for a GNSS—Global Navigation Satellite System—and is designed to determine global position information based on signals from the GNSS. In general, a GNSS is based on various satellites that transmit radio signals. The position can then be deduced from received radio signals. How the GNSS specifically works depends on the particular system. Well-known GNSS systems include GPS, Galileo, Glonass, Beidou and IRNSS.

In one embodiment, the position determination unit is designed to receive beacon signals from several transmitters of known position and to determine an absolute or relative position by analyzing received beacon signals. In this way, a position can also be determined in areas where, for example, the reception of a GNSS signal is not guaranteed. Such transmitters can be Wi-Fi access points, for example. However, dedicated location reference transmitters can also be used, to mention just two conceivable configurations non-exhaustively and restrictively. The beacon signals can be formed by dedicated signals. However, it is also conceivable that “ordinary” radio signals, which are normally used for communication, are used as such beacon signals. As long as a propagation time of the signal or a distance to the respective transmitter can be determined in some other way from received signals, such a signal can in principle be used in the sense of this design. Knowing the position of the transmitters and the distances determined, the position of the mobile terminal can be deduced.

Further features and advantages of the invention can be found in the following description of non-limiting embodiments of the invention, which will be explained in greater detail below with reference to the drawing. This drawing shows schematically:

### BRIEF DESCRIPTION OF THE DRAWINGS

FIG. 1 an exemplary embodiment of a system according to the present disclosure comprising a mobile terminal and a field device, and

FIG. 2 an exemplary embodiment of a method according to the present disclosure.

### DETAILED DESCRIPTION OF THE DRAWINGS

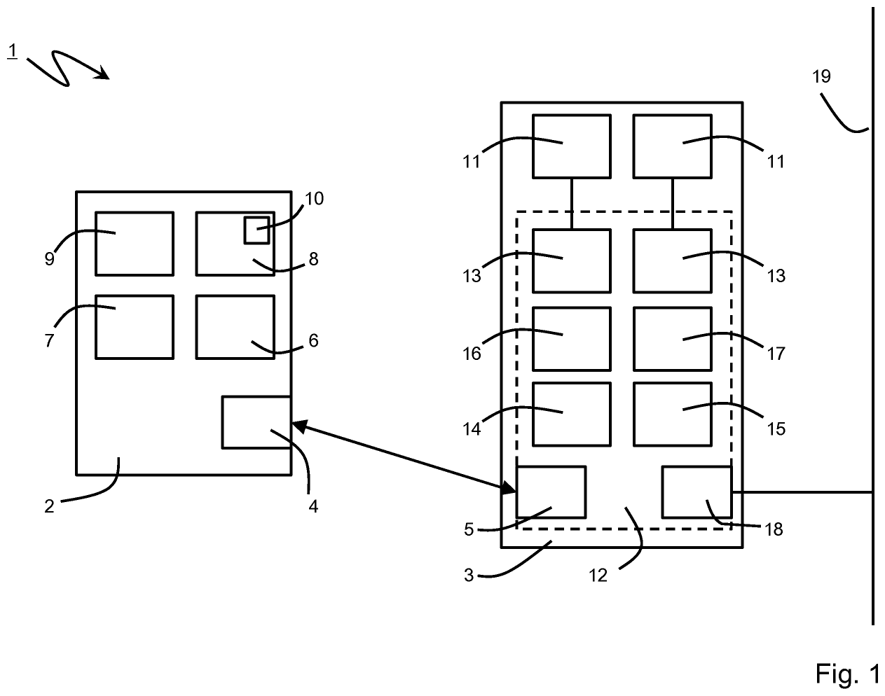

FIG. 1 discloses an exemplary embodiment of a system 1 according to the present disclosure, which comprises a mobile terminal 2 and a field device 3. The mobile terminal 3 can be a suitably programmed smartphone. The mobile terminal 2 comprises a communication interface 4 with which alternating communication with a communication interface 5 of the field device 3 is enabled. This communication interface 4, 5 can be based on the Qi standard, for example so that both data and energy can be transmitted from the mobile terminal 2 to the field device 3. Data can be transmitted in both directions, which is why the two blocks in FIG. 1, which are intended to represent the communication interfaces 4, 5, are connected with a double arrow.

The mobile terminal 2 also comprises a position determination unit 6, a processor 7, a memory 8 and user interfaces 9. The position determination unit 6 is designed to determine a position of the mobile terminal 2 and may comprise a GPS receiver. The memory 8 may contain a computer program product 10 (for example, an app) that can be executed on the processor 7 and enables the mobile terminal 2 to participate in the system 1. The memory 8 can contain volatile memory, for example RAM, and non-volatile memory, for example a flash memory. In addition, further software can be stored in the memory 8, such as an operating system for the mobile terminal 2, for example. The user interfaces 9 can comprise output means, such as a screen or loudspeaker, and input means, such as a touch-sensitive surface of the screen, a keyboard or the like.

The field device comprises two sensors 11 and field device electronics 12. The two sensors 11 each comprise a sensing element (not shown) for detecting a physical variable and are formed, for example, by a point level sensor and a temperature sensor. The sensors 11 are each controlled by an actuation unit 13 in the field device electronics 12. In addition to the communication interface 5 and the two actuation units 13, the field device electronics 12 comprises a control unit 14, a memory 15, a processor 16, a further memory 17 and a further communication interface 18. The memory 15 is designed to store position information and is implemented as a non-volatile memory. The control unit 14 communicates with the communication interface 5 and the memory 15. In this way, the control unit 14 can receive position information from the mobile terminal 2 via the communication interface 5 and store it in the memory 15. The control unit 14 is implemented in a separate microprocessor, which enables a set-up mode with a separate power supply for communication interface 5, control unit 14 and memory 15. The processor 16 is used to control the functions of the field device 3. The processor 16 can access the additional memory 17, which—in this embodiment—is separate from the memory 15 and can, for example, comprise a RAM and flash memory. The additional communication interface 18 enables the field device 3 to be connected to a data bus 19.

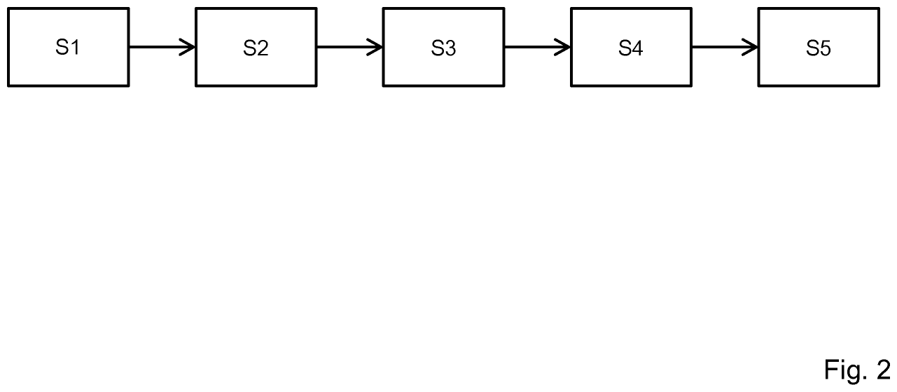

When operating this system 1, a method according to the exemplary embodiment shown in FIG. 2 can be used. In a first step S1, a set-up mode is first activated. For this purpose, it is assumed that the mobile terminal 2 is arranged in the vicinity of the field device 3 and the communication interfaces 4, 5 can communicate with each other. This can also include supplying the communication interface 5, the control unit 14 and the memory 15 via the communication interface 4 and preparing the components involved. In step S2, position information is determined by the position determination unit 6. Since it is assumed that the mobile terminal 2 is located very close to the field device 3, i.e. closer than 10 centimeters, the determined position information of the mobile terminal can be regarded as representative of the field device. In step S3, this determined position information is therefore sent directly and without further adaptation via the communication interface 4 of the mobile terminal 2 to the communication interface 5 of the field device 3. In step S4, the position information is received by the field device 3 and further processed by the control unit 14. In step S5, the received position information is stored in the memory 15.

With regard to further advantageous embodiments, reference is made to the general part of the description and to the appended claims in order to avoid repetition.

Lastly, it should be expressly pointed out that the exemplary embodiments described above serve only to discuss the claimed teaching, but do not limit it to the exemplary embodiments.

### LIST OF REFERENCE SIGNS

1 system
2 mobile device
3 field device
4 communication interface (mobile terminal)
5 communication interface (field device)
6 position determination unit
7 processor (mobile terminal)
8 memory (mobile terminal)
9 user interfaces
10 computer program product
11 sensor
12 field device electronics
13 actuation unit
14 control unit
15 memory
16 processor
17 further memory
18 further communication interface
19 data bus

1. A system for storing position information in a field device, said system at least comprising a field device and a mobile terminal,
wherein the field device has at least one sensor and field device electronics, wherein the at least one sensor has in each case at least one sensing unit for detecting a physical variable, wherein the field device electronics is designed to actuate the at least one sensor and comprises at least one control unit, a communication interface and a memory,
wherein the mobile terminal comprises a communication interface and a position determination unit, wherein the position determination unit is designed to determine position information for describing the position of the mobile terminal in a space,
wherein the communication interface of the mobile terminal and the communication interface of the field device are designed for the mutual exchange of data, preferably within a short range, and for the transmission of position information from the mobile terminal to the field device, and
wherein the control unit of the field device is designed to store position information determined by the mobile terminal and received via the communication interface in the memory.

2. The system according to claim 1, wherein the mobile terminal is designed to transmit position information determined by means of the position determination unit to the field device via the communication interface, wherein the position information determined by means of the position determination unit is assumed to be representative of the position of the field device.

3. The system according to claim 1, wherein the mobile terminal is designed to determine a relative position of the field device relative to the mobile terminal and to determine adapted position information for the field device based on position information determined by means of the position determination unit and the relative position of the field device and to transmit the adapted position information to the field device via the communication interface.

4. The system according to claim 1, wherein the field device electronics is designed to access and/or use position information stored in the memory.

5. The system according to claim 1, wherein the communication interface of the mobile terminal and/or the communication interface of the field device is designed for wireless, preferably radio-based, communication with a maximum range of 10 metres, particularly preferably with a maximum range of 5 metres, very particularly preferably with a maximum range of 1 metre, more preferably with a maximum range of 0.5 metres.

6. The system according to claim 1, wherein the communication interface of the mobile terminal and the communication interface of the field device are additionally designed for energy transmission from the mobile terminal to the field device, wherein energy transmitted via the communication interface (4, 5) can preferably be used to supply the control unit and the memory of the field device.

7. The system according to claim 1, wherein the communication interface of the mobile terminal and the communication interface of the field device are based on Bluetooth®, Bluetooth® LE, NFC—Near Field Communication—or Qi.

8. The system according to claim 1, wherein the field device has a power supply, preferably in the form of a battery and/or in the form of means for energy harvesting, wherein the power supply is designed to supply at least parts of the field device electronics.

9. The system according to claim 1, wherein the field device has a further communication interface, wherein the further communication interface is preferably designed for communication with a bus.

10. The system according to claim 9, wherein the further communication interface is designed to be used for energy transmission for supplying at least parts of the field device electronics.

11. The system according to claim 1, wherein the position determination unit comprises a receiver for a GNSS—Global Navigation Satellite System—and is designed to determine global position information based on signals from the GNSS.

12. The system according to claim 1, wherein the position determination unit is designed to receive beacon signals from a plurality of transmitters of known position and to determine an absolute or relative position by evaluating received beacon signals.

13. A field device with a memory for position information, preferably for use in a system according to claim 1, comprising:
at least one sensor and a field device electronics, wherein the at least one sensor in each case has at least one sensing unit for detecting a physical variable, and wherein the field device electronics is designed to actuate the at least one sensor,
a memory, which is designed to store position information and is arranged in the field device electronics,
a communication interface, which is designed for a two-way exchange of data with a mobile terminal, preferably within a short range, and for receiving position information from the mobile terminal,
a control unit which communicates with the communication interface and the memory and is designed to store position information received via the communication interface in the memory.

14. A method for storing position information in a field device using a mobile terminal, wherein the field device and the mobile terminal each comprise a communication interface for a mutual exchange of data, preferably within a short range, and the field device has field device electronics with a memory, said method comprising:
determining position information for a mobile terminal by means of a position determination unit of the mobile terminal,
transmitting the position information or adapted position information from the mobile terminal to the field device,
receiving the position information or the adapted position information at the field device as received position information, and
storing the received position information as position information representative of the position of the field device in the memory.

15. A computer program product which, when executed on a processor of a mobile terminal, causes a processor in the mobile terminal to:
determine position information for a mobile terminal by means of a position determination unit of the mobile terminal,
transmit the position information or adapted position information from the mobile terminal to a field device, so that the field device can receive the position information or the adapted position information and storing the received position information as position information representative of the position of the field device in a field device memory.
